(19) United States
(12) Patent Application Publication
(10) Pub. No.: US 2024/0300567 A1
(43) Pub. Date: Sep. 12, 2024

(54) VEHICLE WITH STEERING WHEEL WHICH CAN BE TRANSFERRED INTO A NON-STEERING POSITION

(71) Applicant: Ford Global Technologies, LLC, Dearborn, MI (US)

(72) Inventors: Johannes A. Varcus, Sprockhövel (DE); Martin Fassbender, Buschhoven (DE); Philipp Kuepper, Grevenbroich (DE)

(73) Assignee: Ford Global Technologies, LLC, Dearborn, MI (US)

(21) Appl. No.: 18/442,306

(22) Filed: Feb. 15, 2024

(30) Foreign Application Priority Data
Mar. 7, 2023 (DE) 102023105590.9

(51) Int. Cl. B62D 1/10

(52) U.S. Cl. CPC B62D 1/10

(57) ABSTRACT

A vehicle has a steering wheel which can be transferred from a steering position into a non-steering position and vice versa, having a system which only enables the transfer of the steering wheel into the non-steering position when the vehicle is in a non-steered state and when an activation signal for the transfer into the non-steering position. The system includes a monitoring device configured and arranged such that the steering wheel in its non-steering position can be set such that its position with respect to a vehicle occupant is ergonomically optimally adapted at least according to ascertained parameters.

### CROSS-REFERENCE TO RELATED APPLICATION

This application claims foreign priority benefits under 35 U.S.C. § 119(a)-(d) to German Application No. 102023105590.9 filed Mar. 7, 2023, which is hereby incorporated by reference in its entirety.

### FIELD OF THE DISCLOSURE

The present disclosure generally relates to a vehicle steering wheel system, and more particularly relates to vehicles having a steering wheel, which can be transferred from a steering position into a non-steering position and vice versa.

### BACKGROUND OF THE DISCLOSURE

Motor vehicles are commonly equipped with a steering wheel configured to enable the driver to steer the vehicle. A steering wheel has been developed which can be transferred from a steering position into a non-steering position and vice versa. For example, a vehicle may have a steering wheel which may be moved between a driving position, in which a vehicle occupant operates the steering wheel, and a table position, in which a steering wheel axis is aligned in the vertical vehicle direction. In the table position, the steering wheel may function as a table or part of a table which may be used by the vehicle occupant sitting in the driver's seat.

An inclined steering wheel may provide a surface for working or for a lunch break. The position of this surface is determined by the most recently used position of the steering column and the steering wheel in the steering position, i.e. when driving the vehicle, wherein it has been shown that this position (for driving) may differ from a good ergonomic position for the vehicle occupant when the steering wheel is in the non-steering position or table position. The inclined steering wheel surface might be too low, or too high or at a less comfortable angle such that objects supported thereon could slip off, for example, or such that it might lead to tension when working on work devices which are placed thereon.

In this regard, it would be desirable to enhance the transfer of the steering wheel from the steering position into the non-steering position, and vice versa.

### SUMMARY OF THE DISCLOSURE

According to a first aspect of the present disclosure, a vehicle has a steering wheel which can be transferred between a steering position and a non-steering position and a system which only enables the transfer of the steering wheel into the non-steering position when the vehicle is in a non-steered state and when an activation signal for the transfer into the non-steering position is given. The system includes a monitoring device configured and arranged such that the steering wheel in its non-steering position can be set such that its position with respect to a vehicle occupant is adapted at least according to ascertained parameters.

Embodiments of the first aspect of the present disclosure can include any one or a combination of the following features:
one of the ascertained parameters as a vehicle parameter is a vehicle inclination;
the vehicle inclination is along a longitudinal axis and/or transverse axis;
one of the ascertained parameters as a vehicle occupant parameter is the size of a vehicle occupant;
the monitoring device comprises an in-vehicle monitoring system;
the monitoring device comprises a seat position detector for detecting a seat position;
the monitoring device comprises inclination sensors;
the system comprises a steering wheel adjustment device;
the system comprises a steering column adjustment device; and
the system comprises a seat adjustment device.

According to a second aspect of the present disclosure, a vehicle has a steering wheel which can be transferred between a steering position and a non-steering position and a system which only enables the transfer of the steering wheel into the non-steering position when the vehicle is in a non-steered state and when an activation signal for the transfer into the non-steering position is given. The system includes a monitoring device configured and arranged such that the steering wheel in its non-steering position can be set such that its position with respect to a vehicle occupant is adapted at least according to ascertained parameters, wherein the monitoring device comprises an in-vehicle monitoring system, and wherein one of the ascertained parameters as a vehicle parameter is a vehicle inclination.

Embodiments of the second aspect of the present disclosure can include any one or a combination of the following features:
the vehicle inclination is along a longitudinal axis and/or transverse axis;
one of the ascertained parameters as a vehicle occupant parameter is the size of a vehicle occupant;
the monitoring device comprises a seat position detector for detecting a seat position;
the monitoring device comprises inclination sensors;
the system comprises a steering wheel adjustment device;
the system comprises a steering column adjustment device; and
the system comprises a seat adjustment device.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic side view of a vehicle with the steering wheel transferred in stages from a steering position into a non-steering position; and

FIG. 2 is a schematic sideview of the vehicle of FIG. 1 with a system according to one embodiment.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

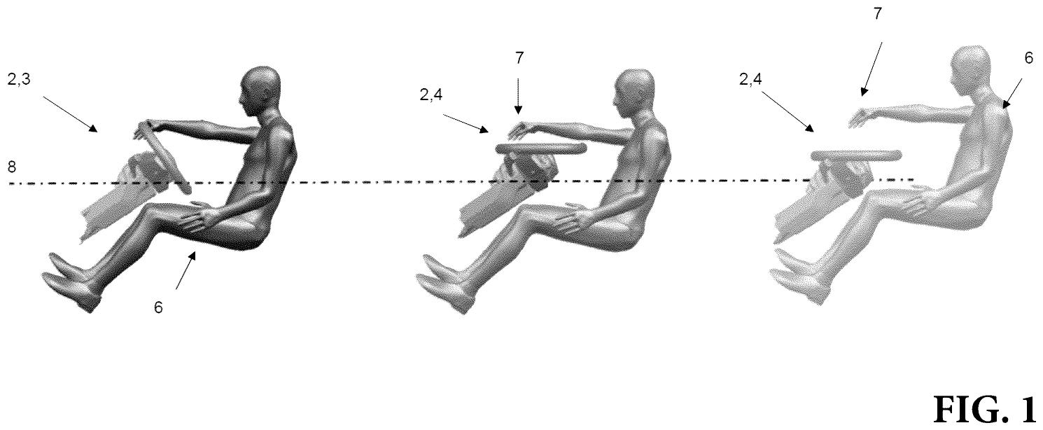

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle with steering wheel which can be transferred between a steering position and a non-steering position. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

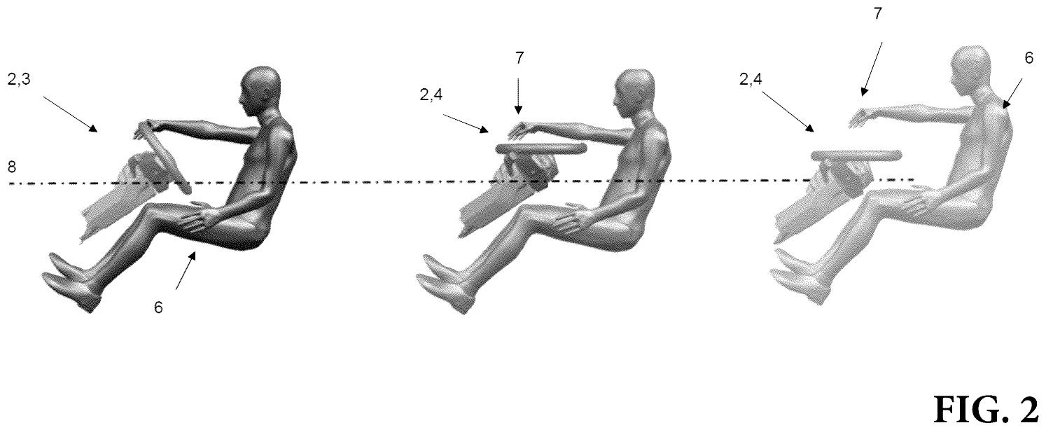

FIG. 1 shows a side view of a detail of a motor vehicle 1 (not shown in FIG. 1, but shown schematically in FIG. 2), whereof the steering wheel 2 can be transferred from a steering position 3 into a non-steering position 4. In the steering position 3, in which the vehicle 1 is possibly in a driven state, the steering wheel 2 is in an optimal position with respect to the vehicle occupant 6. The steering wheel 2 is now transferred from this steering position 3 into the non-steering position 4. With reference to the schematically illustrated vehicle occupant 6, who has his/her hand 7 outstretched for exemplary purposes, it can be seen in FIG. 1 that the steering wheel 2 in its non-steering position 4 may not be set in the ergonomically optimal position (represented by the dot and dash line 8) with respect to the vehicle occupant 6. In the case of the non-steering position 4 shown in the center in the drawing, the steering wheel 2 may be set too high, whereas it may be arranged too low on the far right of the drawing. The vehicle and system discussed herein addresses this situation.

FIG. 2 shows a schematic illustration of the vehicle 1 having the steering wheel 2, which can be transferred from the steering position 3 into the non-steering position 4, and vice versa. As such, the steering wheel 2 moves between the steering position 3 and the non-steering position 4. A floor plate of the vehicle 1 is shown by way of example. The vehicle 1 includes a system 9, which only enables the transfer of the steering wheel 2 into the non-steering position 4 when the vehicle 1 is in a non-steered state and when an activation signal for the transfer into the non-steering position 4 is given. The non-steered state may be ascertained using existing devices, which communicate with a control unit, preferably with a central control unit of the vehicle 1. For example, the actuation of the electronic parking brake (EPB) may be detected as a non-steered state. The activation signal may be triggered manually as a result of the vehicle occupant 6 actuating a control switch. Moreover, the system 9 includes a monitoring device 11, which is configured and arranged such that the steering wheel 2 in its non steering position 4 can be set such that its position with respect to the vehicle occupant 6 is adapted at least according to ascertained parameters.

It can be seen in FIG. 2 that the system 9 includes the monitoring device 11, which has an in-vehicle monitoring system 12 which is arranged inside the vehicle 1, for example on a windshield 13, in FIG. 2. The in-vehicle monitoring system 12 is, for example, an in-vehicle camera, which records parameters relating to the vehicle occupant 6 of a vehicle seat 19 and to the steering wheel 2, which is represented by the schematically illustrated rays emanating from the in-vehicle camera. The size of the vehicle occupant 6 may therefore be determined, wherein the position of the steering wheel 2, in particular in the non-steering position 4, and the position of the vehicle seat 19, and also the elements thereof, may also be determined.

Moreover, the monitoring device 11 illustrated in FIG. 2 has inclination sensors which sense and determine an inclination of the vehicle 1 as a further parameter. It is possible here to detect the inclination of the vehicle 1 along its longitudinal axis and/or at an angle, i.e. transversely, thereto.

The parameters which are recorded as vehicle parameters and as vehicle occupant parameters are transmitted to the control unit, preferably the central control unit, wherein an adaptation of the steering wheel 2 in the non-steering position 4 to an ergonomically optimal position with respect to the vehicle occupant 6 and an adaptation of the horizontal positioning to compensate the vehicle inclination are carried out. The steering wheel 2 which is in the horizontal and ergonomically optimal non-steering position 4 with respect to the vehicle occupant 6 is illustrated schematically as an unshaded bar in FIG. 2. The steering position 3 of the steering wheel 2 can likewise be seen in FIG. 2. Ergonomically non-optimal or non-horizontal positions of the steering wheel 2 in the non-steering position 4, which are avoided by use of the system 9 according to the disclosure, are shown above and below the non-steering position 4 in FIG. 2.

The system 9 moreover features steering column adjustment. both in the longitudinal direction of the column, i.e. up and down, and also transversely thereto, as shown by the double-headed arrows 17 and 18 in FIG. 2. Moreover, the system 9 includes the driver's seat, preferably as an adjustable driver's seat 19, which is adjustable in the longitudinal direction and in the vertical direction, as shown by the cross-shaped arrow 21. A backrest 22 of the driver's seat 19 can likewise be adjusted in terms of its inclination, as shown by the double-headed arrow 23. The driver's seat 19 has a seat pad 24, whereof the inclination with respect to the horizontal plane is likewise adjustable.

The driver's seat position may also be detected by the in-vehicle monitoring system 12 and/or obtained from the most recent driver's seat position stored in the control unit. This may correspond to the driver's seat position in the driven state of the vehicle 1, so that, in an ideal configuration of the system 9, the driver's seat position in the non-steering position 4 of the steering wheel 2 is likewise adapted according to the ascertained parameters. In this regard, in conjunction with the adjustment of the steering wheel 2 (including the steering column) by an actuator and the adjustment of the driver's seat by an actuator, it is possible to set the ergonomically correct position of the steering wheel 2 in its non-steering position 4 relative to the vehicle occupant 6.

A system 9 for automatic optimization of an ergonomic position of an inclinable steering wheel 2 of a vehicle 1 is provided. In the steering position 3, the steering wheel 2 is ideally aligned fairly high with respect to the vehicle occupant 6. In the table position, i.e. in the horizontal non-steering position 4, the steering wheel 2 is ideally aligned very low with respect to the vehicle occupant 6. The system 9 comprises an electrical assist system for adjusting a driver's seat and/or a steering column, and possibly the steering wheel 2, via an actuator when the vehicle is in the non-driven state (parked vehicle, EPB activated, non-driven mode, etc.). The system 9 may have a steering wheel inclination button, which is activated when the vehicle is not in the steered state. The steering wheel 2 can be inclined so that it is in the horizontally aligned, non-steering position 4 and has a table function for placing drinks, food, a lunch box and the like thereon. The steering wheel 2 may also be used as a work surface for placing a laptop and the like thereon, wherein, to this end, a position which is not necessarily horizontal is regarded as the optimal steering wheel position. In this regard, it is possible to for further ergonomically optimal intermediate positions of the steering wheel 2 as the non-steering position 4 to be set by the system 9, possibly as requested and weighted by the vehicle occupant 6, which intermediate positions may be between the horizontal non-steering position 4 and the steering position 3 of the steering wheel 2. The intermediate positions as the non-steering position 4 are preferably continuously adjustable between the steering position 3 and the horizontal non-steering position 4. The system 9 enables the steering column to be locked when the steering wheel 2 is in the non-steering position 4. This measure prevents the steering wheel 2 from rotating in the non-steering position 4. The system 9 includes an internal detection system, i.e. an in-vehicle monitoring system 12 (e.g. camera, in-vehicle sensor, radar etc.), which detects the size of a vehicle occupant 6 and the position of the steering wheel 2 in the non-steering position 4. By use of the monitoring device 12, it is possible to compare the position of the steering wheel 2 in the non-steering position 4 with an optimal steering wheel position based on the size of the vehicle occupant 6 and the vehicle inclination. This optimal steering wheel position may be stored, for example, in a table in the control unit so that a corresponding control signal is transmitted to the various actuators.

The system 9 automatically sets the steering column and the driver's seat, and also the steering wheel inclination, back to the respective optimal driving position when the steering wheel 2 is in the steering position 3.

In a possible configuration, the system 9 may store personalized profiles (steering column profiles and/or seat height and angle profiles) for each vehicle occupant 6 (e.g. for the state of the steering wheel 2 in the non-steering position 4 and for the driving state, i.e. when the steering wheel 2 is arranged in the steering position 3), so that the vehicle occupant 6 is provided with the optimal setting based on the steering wheel status. The system 9 may activate the stored profiles via one or more personal identification systems.

The disclosure relates to a vehicle which provides an improved system for transferring the steering wheel from its steering position into its non-steering position and back again to its steering position. While modern OEMs of passenger vehicles would currently warn against setting the steering wheel in the non-steering position and using the work surface while the vehicle is in motion due to safety concerns, it is anticipated that technology and regulatory framework may evolve in the future to where such an activity is safe and permissible.

It should be pointed out that the features and measures specified individually in the description may be combined with one another in any desired technically meaningful way and disclose further configurations of the vehicle. The description additionally characterizes and specifies the vehicle, in particular in conjunction with the figures.

A vehicle is disclosed which has a steering wheel which can be transferred from a steering position into a non-steering position and vice versa, having a system which only enables the transfer of the steering wheel into the non-steering position when the vehicle is in a non-steered state and when an activation signal for the transfer into the non-steering position is given, wherein the system includes a monitoring device, which is configured and arranged such that the steering wheel in its non-steering position can be set such that its position with respect to a vehicle occupant is ergonomically optimally adapted at least according to ascertained parameters.

In this disclosure, a vehicle is disclosed wherein the positioning of the steering wheel in the non-steering position is adapted according to various conditions and the steering wheel in the non-steering position is thus arranged horizontally and/or in an ergonomically optimal position with respect to the vehicle occupant. In an ideal configuration, the vehicle or the system comprises a steering column which can be adjusted by an actuator and a steering wheel which can be adjusted by an actuator. It is possible to set the height of the steering wheel via the steering column, which can be adjusted by an actuator, and also the angle of the steering column with respect to the horizontal and the distance from the vehicle occupant. In the case of the steering wheel which can be adjusted by an actuator, this may be transferred, for example, from the steering position into the non-steering position and back again. In accordance with the disclosure, the idea is to also compensate vehicle inclinations, which will be discussed in further detail below. For adjustment by an actuator, electric motors may be used, for example, which communicate with a control unit, in particular with a central control unit (CPU) of the vehicle via a wired connection or wirelessly. If the steering wheel is in its non-steering position, the monitoring device detects the actual position of the steering wheel with respect to the vehicle occupant and alters this position to achieve a linear and ergonomically optimal position relative to the vehicle occupant in the respective position of the vehicle. To this end, the monitoring device advantageously records the parameters which are included when setting the optimal position, wherein the corrective adjustment takes place in particular in an automated manner.

In accordance with the disclosure, a vehicle occupant is a person who is driving the vehicle, i.e. is sitting in the driver's seat. A non-steered state, in accordance with the disclosure, is a state in which the vehicle is stationary, i.e. is not moving, i.e. effectively parked, so it might also be referred to as a non-driven state. However, in automated vehicles, a non-steered state may also be present when moving, i.e. during autonomous driving.

The monitoring device preferably has inclination sensors, which ascertain an inclination of the vehicle along its longitudinal axis and/or at an angle or transversely thereto. A parameter may be a vehicle parameter, for example an inclination of the vehicle, wherein, as a vehicle parameter, it is therefore determined whether the vehicle is parked on an inclined surface. It is possible to detect the inclination of the vehicle along the longitudinal axis of the vehicle, but also transversely thereto. If the steering wheel has been arranged in a fixed non-steering position in the vehicle, it may be that an object which is placed on the steering wheel may slip off it owing to the inclination of the vehicle. This may be avoided since the steering wheel in its non-steering position may preferably be arranged in the horizontal plane such that it is always adapted according to the angle of inclination of the vehicle. To this end, the adjustment is undertaken by the relevant actuators, which receive a corresponding control signal from the control unit. The inclination of the vehicle may be recorded by sensors which are present in any case. This is expedient in that both the ascertained inclination of the vehicle with respect to the longitudinal axis, but possibly also at an angle or transversely thereto, is compensated by use of the system through activation of the corresponding actuators.

Further parameters preferably referring to the vehicle occupant may be obtained as vehicle parameters. To this end, the monitoring device includes an in-vehicle monitoring system. The in-vehicle monitoring system may comprise at least one in-vehicle camera and/or at least one in-vehicle sensor or it may also be radar based, to name just a few examples of in-vehicle monitoring which are not intended to be restrictive. The in-vehicle monitoring system detects the size of the vehicle occupant and also the position of the steering wheel in the non-steering position relative to the vehicle occupant. Using the size of the vehicle occupant, a parameter for height-adjustment of the steering wheel in the non-steering position is detected so that the steering wheel is moved into the optimum position by an actuator. Additionally, the steering wheel inclination relative to the vehicle occupant is furthermore detected so that it can also be set in the optimal position, wherein distance adaptation may also take place. The parameter for vehicle inclination may also be included here so that the steering wheel is set level with the horizontal when the vehicle is parked on an inclined surface. In this regard, by use of the in-vehicle monitoring system, it is also ascertained whether the steering wheel is in the ergonomically favorable, i.e. optimal position, while the steering wheel is preferably transferred into the horizontal position so as to prevent objects from slipping off. The optimization of the “table height” of the steering wheel in its non-steering position should ideally not lead to a substantial change in the table inclination (e.g. the steering column is raised or lowered, the seat is raised or lowered). However, it may be the case here that an ergonomically optimal steering wheel angle in its non-steering position does not necessarily correspond to a horizontally aligned steering wheel. In particular, it is therefore provided that the vehicle occupant receives a notification to indicate that there is a discrepancy between the ergonomically optimal steering wheel angle and the horizontal alignment of the steering wheel, with the result that a corresponding weighting signal is requested from the vehicle occupant in order to align the steering wheel either in the ergonomically optimal position or in the horizontal position in its non-steering position. By way of example, a horizontal steering wheel position in the non-steering position may be desired if the objects to be placed on the steering wheel should not slip off. The system might then set the steering wheel in the level, i.e. horizontal position, in its non-steering position. By way of example, an ergonomically optimal position in an intermediate position of the non-steering position may be desired if a work device, for example a tablet, notebook or the like, is to be placed thereon for use. The system might then adapt the angle of the steering wheel in its non-steering position to the ergonomically favorable, i.e. optimal position, wherein the steering wheel in its non-steering position is not moved out of the horizontal plane to such an extent that objects are able to slip off. The weighting signal may be input via voice recognition, for example, wherein, if the vehicle occupant operates a control switch to alter the angle of the steering wheel via an actuator in the non-steering position, this may also be regarded as weighting. In this regard, confirmation from the vehicle occupant may also be requested by the system in particular in the case of a conventional steering system (not steer-by-wire). It goes without saying that it is in accordance with the disclosure if the steering wheel position in the non-steering position, which is set in an automated manner, is corrected according to an individual request by the vehicle occupant, which may likewise be input via voice recognition and/or input via a control switch.

The vehicle occupant referred to is preferably sitting on a driver's seat. This may also be adjusted by an actuator by use of corresponding electric motors. It is favorable if the monitoring device features seat position detection as a vehicle parameter. This may be separate from the in-vehicle monitoring system or it may be integrated therein. In a further preferred configuration, the system may comprise a seat adjustment system, which may be activated in conjunction with the movement of the steering wheel into its non-steering position. The driver's seat is adjustable here in terms of its longitudinal position, in terms of its vertical position and in terms of the inclination of its seat pad and/or its backrest. The driver's seat position may also be detected by the in-vehicle monitoring system and/or obtained from the most recent driver's seat position stored in the control unit. This may correspond to the driver's seat position in the driven state of the vehicle, so that, in an ideal configuration of the system, the driver's seat position in the non-steering position of the steering wheel is likewise adapted according to the ascertained parameters. In this regard, in conjunction with the adjustment of the steering wheel by an actuator and the adjustment of the driver's seat by an actuator, it is possible to set the ergonomically optimal position of the steering wheel in its non-steering position relative to the vehicle occupant.

The system returns the steering wheel, and possibly also the driver's seat, to the previously set steering position when the vehicle occupant inputs a corresponding signal, e.g. via voice recognition and/or a control switch. Alternatively, the tiltable steering wheel may be pivoted back into the steering position by the vehicle occupant.

The vehicle occupant may always be provided with the optimal ergonomic position while driving and when parking and when using the inclined steering wheel in the non-steering position, without having to manually readjust the height of the steering column, the angle of the steering column and/or the height and the angle of the driver's seat. This is very advantageous, in particular when the inclined function, i.e. the non-steering position of the steering wheel, is used.

In the event that in-vehicle monitoring is not available, a plurality of personalized profiles, preferably two personalized profiles, for the height and the angle of the steering column and the driver's seat might be stored, one for the state of the tilted steering wheel and one for the driving state, so that the optimal setting for each driver may be provided depending on the steering wheel status (tilted/non-tilted). These profiles may be stored and activated via personal identification systems (e.g. Ford MyKey or camera-based driver recognition).

A system for automatic optimization of an ergonomic position of a vehicle steering wheel which can be inclined so that it is in the non-steering position is provided. The system comprises an electrical assist system for adjusting a driver's seat and/or a steering column via an actuator when the vehicle is not in the driven state (parked vehicle, EPB activated, non-driven mode, etc., but also in the case of autonomous driving). The system may have a steering wheel inclination button, which is activated when the vehicle is not in the driven state. The steering wheel can be inclined so that it is in the horizontally aligned, non-steering position and has a table function for placing a laptop, lunch box, etc. thereon. The system enables the steering column to be locked when the steering wheel is in the non-steering position. This measure prevents the steering wheel from rotating in the non-steering position. The system comprises an internal detection system, i.e. an in-vehicle monitoring system (e.g. camera, in-vehicle sensor, radar etc.), which detects the size of a vehicle occupant and the position of the steering wheel in the non-steering position. The monitoring device compares the position of the steering wheel in the non-steering position with an optimal steering wheel position based on the size of the vehicle occupant. This may be stored, for example, in a table in the control unit so that a corresponding control signal is transmitted to the various actuators. This also includes the monitoring parameters relating to the vehicle inclination, which may be compensated by use of the system. In a possible configuration, the system may store personalized profiles (steering column profiles and/or seat height and angle profiles) for each vehicle occupant (e.g. for the state of the steering wheel in the non-steering position and for the driving state, i.e. when the steering wheel is arranged in the steering position), so that the driver is provided with the optimal setting based on the steering wheel status. The system may activate the stored profiles via one or more personal identification systems. The system automatically sets the steering column and the driver's seat, and also the steering wheel inclination, back in the respective optimal driving position when the steering wheel is in the steering position.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle comprising:
a steering wheel which can be transferred between a steering position and a non-steering position; and
a system which only enables the transfer of the steering wheel into the non-steering position when the vehicle is in a non-steered state and when an activation signal for the transfer into the non-steering position is given, the system comprising a monitoring device configured and arranged such that the steering wheel in its non-steering position can be set such that its position with respect to a vehicle occupant is adapted at least according to ascertained parameters.

2. The vehicle according to claim 1, wherein one of the ascertained parameters as a vehicle parameter is a vehicle inclination.

3. The vehicle as claimed in claim 2, wherein the vehicle inclination is along a longitudinal axis and/or transverse axis.

4. The vehicle according to claim 1, wherein one of the ascertained parameters as a vehicle occupant parameter is the size of a vehicle occupant.

5. The vehicle according to claim 1, wherein the monitoring device comprises an in-vehicle monitoring system.

6. The vehicle as claimed in claim 1, wherein the monitoring device comprises a seat position detector for detecting a seat position.

7. The vehicle as claimed in claim 1, wherein the monitoring device comprises inclination sensors.

8. The vehicle as claimed in claim 1, wherein the system comprises a steering wheel adjustment device.

9. The vehicle as claimed in claim 1, wherein the system comprises a steering column adjustment device.

10. The vehicle as claimed in claim 1, wherein the system comprises a seat adjustment device.

11. A vehicle comprising:
a steering wheel which can be transferred between a steering position and a non-steering position; and
a system which only enables the transfer of the steering wheel into the non-steering position when the vehicle is in a non-steered state and when an activation signal for the transfer into the non-steering position is given, the system comprising a monitoring device configured and arranged such that the steering wheel in its non-steering position can be set such that its position with respect to the vehicle occupant is adapted at least according to ascertained parameters, wherein the monitoring device comprises an in-vehicle monitoring system, and wherein one of the ascertained parameters as a vehicle parameter is a vehicle inclination.

12. The vehicle as claimed in claim 11, wherein the vehicle inclination is along a longitudinal axis and/or transverse axis.

13. The vehicle according to claim 11, wherein one of the ascertained parameters as a vehicle occupant parameter is the size of the vehicle occupant.

14. The vehicle as claimed in claim 11, wherein the monitoring device comprises a seat position detector for detecting a seat position.

15. The vehicle as claimed in claim 11, wherein the monitoring device comprises inclination sensors.

16. The vehicle as claimed in claim 11, wherein the system comprises a steering wheel adjustment device.

17. The vehicle as claimed in claim 11, wherein the system comprises a steering column adjustment device.

18. The vehicle as claimed in claim 11, wherein the system comprises a seat adjustment device.
